(19) United States
(12) Patent Application Publication
(10) Pub. No.: US 2024/0296816 A1
(43) Pub. Date: Sep. 5, 2024

(54) TECHNIQUES FOR USING LASER-BASED CYMATICS TO PHYSICALIZE SOUND

(71) Applicants: Cassidy Bach, SALT LAKE CITY, UT (US); Steven Erb, SALT LAKE CITY, UT (US)

(72) Inventors: Cassidy Bach, SALT LAKE CITY, UT (US); Steven Erb, SALT LAKE CITY, UT (US)

(21) Appl. No.: 18/595,169

(22) Filed: Mar. 4, 2024

Related U.S. Application Data
(60) Provisional application No. 63/488,326, filed on Mar. 3, 2023.

(51) Int. Cl. G10G 1/00; G06T 1/00; G06T 7/50; G06T 11/00

(52) U.S. Cl. CPC G10G 1/00; G06T 1/0007; G06T 7/50; G06T 11/00; G06T 2207/10016

(57) ABSTRACT

Methods, systems, and devices for sensory transformation are described. In accordance with the techniques described herein, a reflecting component (such as a mirror) may be appended to the front of a latex membrane, and a laser may be positioned such that a beam of the laser reflects off the reflecting component and onto an opaque surface (such as a canvas or screen). An exciter component may output an audio waveform associated with a user-selected audio sample. The audio waveform may cause the latex membrane and the reflecting component to oscillate. The oscillatory movement of the reflecting component may cause the reflected beam to fluctuate on the opaque surface. Images of the path (i.e., motion) of the reflected beam on the opaque surface may be captured, stored, and converted into data files. The data files may be used to generate tangible objects associated with the user-selected audio sample.

### CROSS-REFERENCE

The present application for patent claims the benefit of U.S. Provisional Patent Application No. 63/488,326, entitled “TECHNIQUES FOR USING LASER-BASED CYMATICS TO PHYSICALIZE SOUND,” filed Mar. 3, 2023, the entire contents of which are expressly incorporated by reference herein.

### FIELD OF TECHNOLOGY

The present disclosure relates generally to sensory processing, and more specifically to techniques for using laser-based cymatics to physicalize sound.

### BACKGROUND

An individual may be exposed to a variety of stimuli, such as sights, sounds, smells, etc. Some types of stimuli (such as sights and sounds) may occur more frequently than others. Thus, an individual may use some senses (for example, touch) less frequently than others, leading to sensory saturation and/or deprivation. Furthermore, some individuals with sensory impairments (such as congenital blindness) may be unable to perceive and/or interpret some types of stimuli in the same way that others do.

### BRIEF DESCRIPTION OF THE DRAWINGS

FIGS. 1 and 2 illustrate examples of systems that support techniques for using laser-based cymatics to physicalize sound in accordance with one or more aspects of the present disclosure.

FIGS. 3 and 4 illustrate examples of object diagrams that support techniques for using laser-based cymatics to physicalize sound in accordance with one or more aspects of the present disclosure.

FIG. 5 illustrates a block diagram of a system that supports techniques for using laser-based cymatics to physicalize sound in accordance with one or more aspects of the present disclosure.

FIG. 6 illustrates a diagram of a system including a device that supports techniques for using laser-based cymatics to physicalize sound in accordance with one or more aspects of the present disclosure.

FIG. 7 illustrates a flowchart that supports techniques for using laser-based cymatics to physicalize sound in accordance with one or more aspects of the present disclosure.

### DETAILED DESCRIPTION

An individual may be exposed to a variety of sensory stimuli, such as auditory stimuli (i.e., sounds), olfactory stimuli (i.e., smells), visual stimuli (i.e., sights), gustatory stimuli (i.e., tastes), and tactile stimuli (i.e., touch). However, some individuals may be unable to experience or otherwise perceive certain types of stimuli. For example, individuals with visual impairments (such as blindness) may be unable to perceive and/or process certain visual stimuli. Similarly, individuals with hearing impediments (such as deafness) may be unable to perceive and/or process certain auditory stimuli. Additionally, some types of stimuli (such as visual and auditory stimuli) may occur more frequently than other types of stimuli (such as tactile stimuli), leading to sensory overstimulation (i.e., saturation) and/or deprivation.

Cymatics generally refers to the process of converting auditory stimuli (for example, audio waveforms) into visual stimuli (for example, shapes) by capturing the vibrational effects that are caused (e.g., induced) by sound waves. As described herein, a sound wave may be defined as a sequence of longitudinal pressure waves (for example, waves in which the displacement of a medium is in the same direction as, or the opposite direction to, the direction of propagation) that expand or compress the molecules of a medium (such as air). Cymatics can be used to visualize the physical shape of captured sound. However, individuals with visual impairments (such as blindness or vision loss) may be unable to fully experience the visual effects of cymatics.

Aspects of the present disclosure support techniques for using cymatics to transform audio signals (for example, waveforms) into tangible objects, thereby enabling individuals to perceive and interact with the shape and texture of sound. In accordance with aspects of the present disclosure, a reflecting component may be appended to the front of a latex membrane, and a laser may be positioned such that a beam of the laser reflects off the reflecting component and onto an opaque surface. An exciter component may output an audio waveform associated with a user-selected audio sample (for example, a song or a voice recording). The audio waveform may cause the latex membrane and the reflecting component to oscillate. The oscillatory movement of the reflecting component may cause the reflected beam to fluctuate on the opaque surface. Images of the path (i.e., motion) of the reflected beam on the opaque surface may be captured, stored, and converted into data files.

Accordingly, the data files (e.g., vector files that include graphic information associated with the captured images) may be used to generate tangible objects associated with the user-selected audio sample. For example, a laser cutter or three-dimensional (3D) printer can be used to create modular objects (also referred to herein as slices) based on the data files. In some implementations, these modular objects can be flexibly connected using directional magnets, thereby providing users with the ability to rotate and/or rearrange the modular objects. In some examples, the arrangement, length, or configuration of the modular objects may correspond to a specific musical note (such as b1), thereby enabling users to perceive audio tones/frequencies using other senses (such as sight and touch).

Aspects of the present disclosure may be implemented to realize one or more of the following advantages. The techniques described herein may provide individuals with a new way to interact with sound, for example, by enabling users to convert audio signals into tangible objects that can be experienced through sight, smell, touch, and taste. In some examples, the techniques described herein may enable individuals with hearing impediments to process and/or interpret audio information using other sensory means. Furthermore, the described techniques may enable individuals with visual impairments to experience the sensory phenomena of cymatics (i.e., the visualization of sound) through touch. Additionally, the described techniques may provide musicians with an alternate way to read or write musical compositions (for example, by rearranging or interacting with tangible objects that correspond to musical notes).

Aspects of the disclosure are initially described in the context of systems and object diagrams. Aspects of the disclosure are further illustrated by and described with reference to block diagrams and flowcharts that support techniques for using laser-based cymatics to physicalize sound.

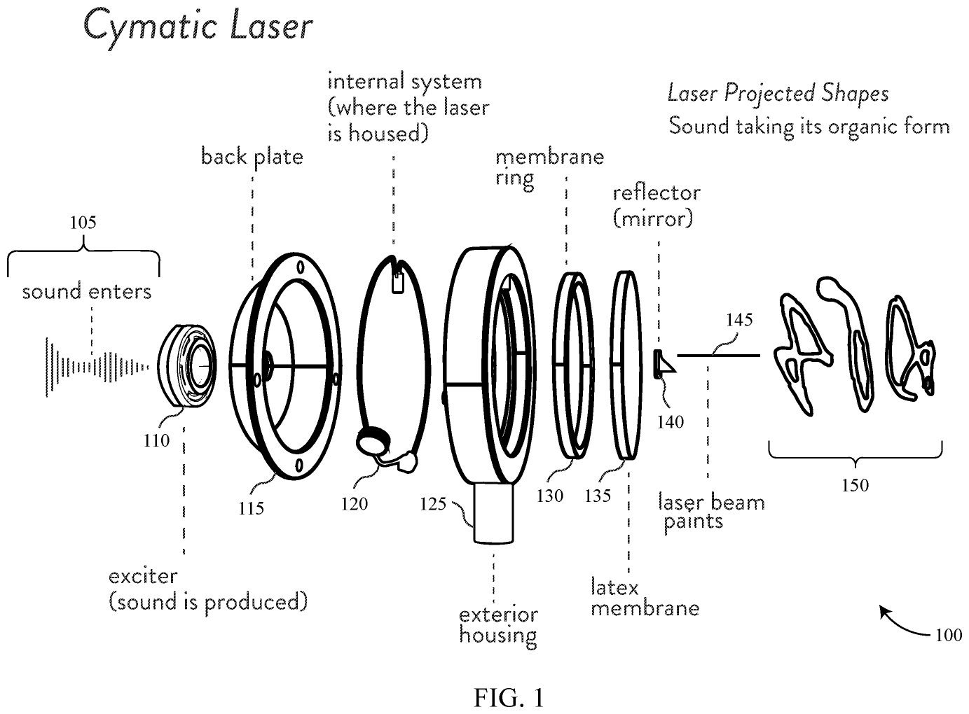

FIG. 1 illustrates an example of a system 100 that supports techniques for using laser-based cymatics to physicalize sound in accordance with various aspects of the present disclosure. The system 100 includes an audio waveform 105 (i.e., a sound wave), an exciter component 110 (i.e., an audio output component), a back plate 115 (also referred to herein as a rigid shell), an internal system 120, an exterior housing component 125, a membrane ring 130 (also referred to herein as a compression ring), a latex membrane 135, a reflector 140 (e.g., a mirror or any material with reflective properties), a laser beam 145, and laser-projected shapes 150. The internal system 120 may include a laser coupled (e.g., operatively, communicatively, functionally, electronically, or electrically) with a switch and a battery.

In the example of FIG. 1, the exciter component 110 may be coupled to the back plate 115. The exciter component 110 may be configured to output the audio waveform 105, which may correspond to a user-selected audio sample (such as a voice recording, a song, or environmental/ambient noise levels). The exterior housing component 125 may be rigidly coupled to the back plate 115. The internal system 120 may be mounted or otherwise positioned between the back plate 115 and the exterior housing component 125. The membrane ring 130 may be coupled to the exterior housing component 125 and the latex membrane 135. The reflector 140 may be appended or otherwise attached to the surface of the latex membrane 135.

The laser (of the internal system 120) may be trained on the reflector 140 such that the laser beam 145 reflects off the surface of the reflector 140 and onto an opaque surface, such as a wall, canvas, screen, etc. When the exciter component 110 emits the audio waveform 105, vibrations associated with the audio waveform 105 may cause the latex membrane 135 and the reflector 140 to oscillate. The oscillations induced by the audio waveform 105 may alter the path of reflection between the laser, the reflector 140, and the opaque surface, thereby causing laser-projected shapes 150 to appear on the opaque surface.

As the reflector 140 continues to vibrate, an image capturing component (such as a camera or phone) may capture images of the laser-projected shapes 150 on the opaque surface. In some implementations, images may be extracted or otherwise selected from a video feed of the surface. The images may be captured or extracted at set time intervals (for example, every second). Thus, each of the laser-projected shapes 150 may represent the path of the laser beam 145 over a discrete time interval. Once captured, the images may be stored and converted into data files (such as .AI files) that can be used to generate tangible (i.e., physical, tactile) objects associated with the user-selected audio sample.

In one implementation, a user may use a recording device to collect audio data from one or more target locations (i.e., public spaces, social hubs, parks). Thereafter, waveforms from the collected audio data may be reproduced (i.e., replayed) via the exciter component 110. The waveforms from the exciter component 110 may cause the laser beam to fluctuate, resulting in the laser-projected shapes 150. Images of the laser-projected shapes 150 may then be uploaded, processed, and used to generate various tangible objects that physically resemble the audio data from the one or more target locations.

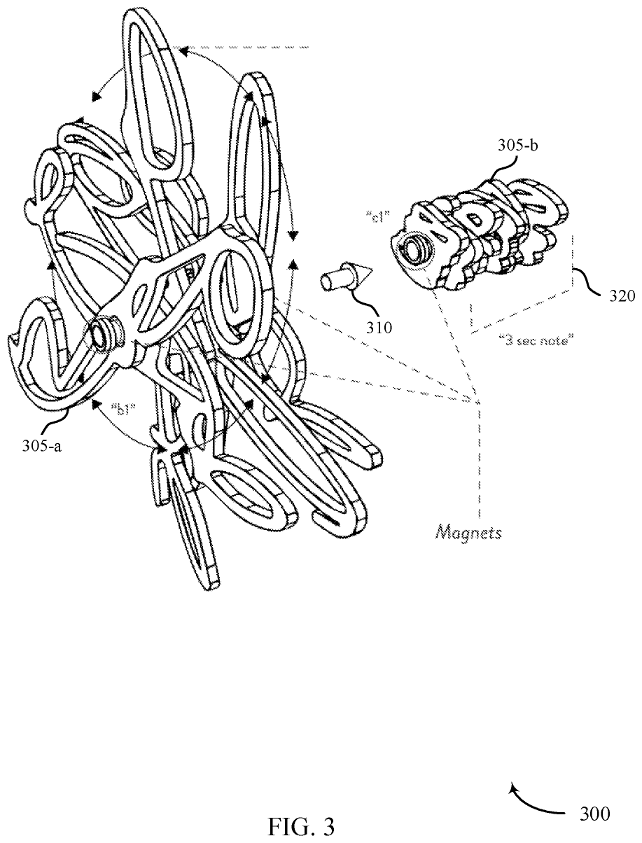

Aspects of the system 100 may be implemented to realize one or more of the following advantages. The techniques described with reference to FIG. 1 may positively impact blind people (and other users) by providing a new way to understand, process, and interpret sound. The musical models disclosed herein (such as the tangible objects 305 described with reference to FIG. 3) may use touch to change the way that people learn and experience music.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes described herein. However, the description and appended drawings only include example technical improvements resulting from implementing aspects of the disclosure, and, accordingly, do not represent all of the technical improvements provided within the scope of the claims.

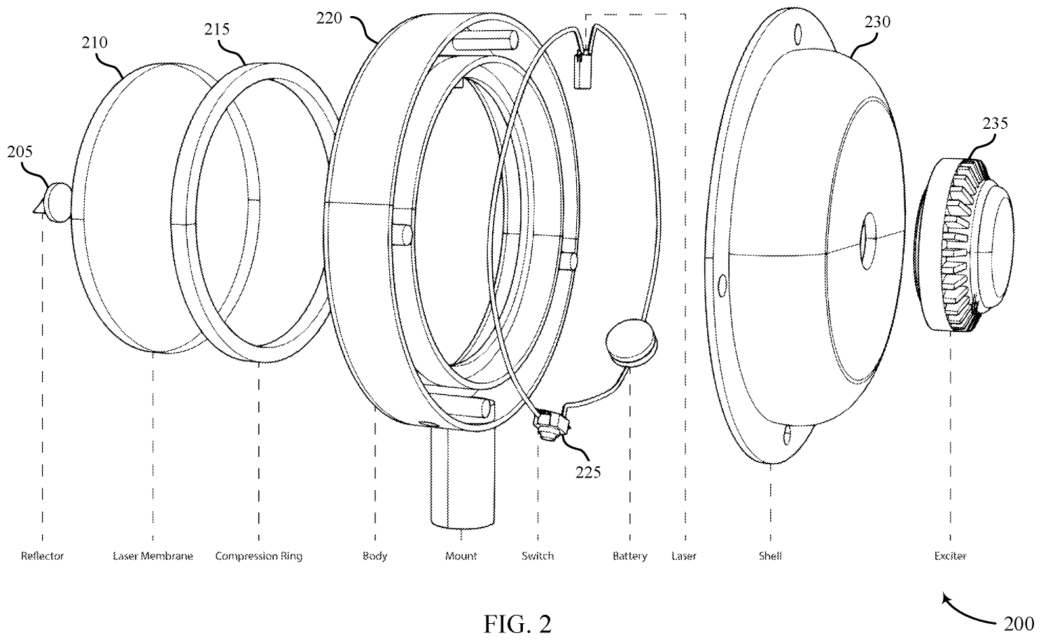

FIG. 2 shows an example of a system 200 that supports techniques for using laser-based cymatics to physicalize sound in accordance with one or more aspects of the present disclosure. The system 200 may implement or be implemented by aspects of the system 100. For example, the system 200 includes an exciter component 235, which may be an example of the exciter component 110 described with reference to FIG. 1. The system 200 also includes a reflector 205, a laser membrane 210, a compression ring 215, a housing component 220, a laser circuit 225, and a shell component 230, which may be examples of corresponding components and elements described herein, including with reference to FIG. 1.

In the example of FIG. 2, the exciter component 235 may be fastened to the shell component 230. The exciter component 235 may be configured to output an audio waveform that corresponds to a user-selected audio sample (such as a voice recording, a song, or environmental/ambient noise levels). The housing component 220 may be rigidly coupled to the shell component 230. The housing component 220 may be composed of a body and a mount. The laser circuit 225 may be mounted or otherwise positioned between the shell component 230 and the housing component 220. The compression ring 215 may be coupled to the housing component 220 and the laser membrane 210. The reflector 205 may be appended or otherwise attached to the surface of the laser membrane 210.

The laser circuit 225 may include a laser coupled (e.g., operatively, communicatively, functionally, electronically, or electrically) with a switch and a battery. The laser may be trained on (i.e., directed at) the reflector 205 such that a beam of the laser reflects off the surface of the reflector 205 and onto the opaque surface, such as a wall, canvas, screen, etc. When the exciter component 235 emits an audio waveform, vibrations associated with the audio waveform may cause the laser membrane 210 and the reflector 205 to oscillate. The oscillations induced by the audio waveform may alter the path of reflection between the laser, the reflector 205, and the opaque surface, thereby causing laser-projected shapes to appear on the opaque surface.

As the reflector 205 continues to vibrate, an image capturing component (such as a camera or recording device) may capture images of the laser-projected shapes on the opaque surface. In some implementations, the images may be extracted or otherwise selected from video footage of the surface. The images may be captured or extracted at set time intervals. Thus, each of the laser-projected shapes may represent the path of the laser beam over a discrete time interval. Once captured, the images may be stored and converted into data files (such as .AI files) that can be used to generate tangible (i.e., physical, tactile) objects associated with the user-selected audio sample.

As described herein, various software programs can be used to capture, store, and convert images of the laser-projected shapes into 3D objects. In some implementations, images of the laser-projected shapes can be saved as .JPEG or .PNG files and subsequently converted into data files using a vector graphics editing software (such as Adobe Illustrator or Photoshop) or a computer-aided design (CAD) program (such as SolidWorks or AutoCAD). The resulting data files can be used to program a laser cutter, 3D printer, etc. For example, a laser cutter may be programmed to trace the outline of a laser-projected shape on a sheet of plexiglass or acrylic material. Likewise, a 3D printer may be programmed to print the laser-projected shapes using 3D printing materials (such as plastic filament).

In some examples, the tangible objects may include modular slices (i.e., still-cuts) that correspond to the laser-projected shapes (as described with reference to FIG. 3). These modular slices may be connected (e.g., using directional magnets or other flexible connectors) or suspended from a central frame, thereby providing users with the ability to interact with the tangible objects individually or combination. Other examples of tangible objects include items of clothing (e.g., t-shirts) with imprints of the laser-projected shapes, lighting fixtures (i.e., chandeliers) that resemble the laser-projected shapes, desk ornaments, public art pieces, edible objects, etc.

Other object variations and applications are also contemplated within the scope of the present disclosure. For example, one or more of the tangible objects described herein can be used as a post-stroke therapy tool for learning and recovery, a learning tool for musicians and students, a learning tool for the blind and deaf, an urban planning tool, a health tracking tool, a public art piece, a museum exhibition, a vase, a bike rack, a playground, a kitchenware design, an architectural design, etc.

FIG. 3 shows an example of an object diagram 300 that supports techniques for using laser-based cymatics to physicalize sound in accordance with one or more aspects of the present disclosure. The object diagram 300 may implement or be implemented by aspects of the system 100 or the system 200. For example, the object diagram includes a tangible object 305-a and a tangible object 305-b, which may be examples of corresponding objects described herein, including with reference to FIGS. 1 and 2. The tangible objects 305 may be composed of modular slices (i.e., segments) that resemble laser-projected shapes (such as the laser-projected shapes 150 described with reference to FIG. 1). In some examples, the modular slices of the tangible objects 305 may be connected by directional magnets 310.

As described herein, touch may be underutilized in comparison to other senses (namely, sight and sound). Sound is predominantly experienced in the form of oral and/or auditory stimuli, and may detract from experiencing other sensory experiences (i.e., touch). The tangible objects 305 depicted in the object diagram 300 may be touch-based, modular, musical tools. In some implementations, each “note” (e.g., tangible object) may include 6 slices that spin freely to allow more tactile access. Each note model may be connected with magnets 310 to allow users to rearrange, create, and compose their own music. The techniques described with reference to FIG. 3. may enable users to interact with the physical shape of captured sound, which can be beneficial in cases where auditory and visual stimulation has reached a degree of saturation.

In some examples, the tangible objects 305 may be composed of plexiglass to provide optimal textile stimulation and a smooth texture. The constituent slices of the tangible objects 305 (and the tangible objects 305 themselves) can be connected, rearranged, and/or disconnected to design musical compositions through physical interaction. In the example of FIG. 3, the tangible object 305-a may represent the musical note of “b1”, while the tangible object 305-b may represent the musical note of “cl”. In some examples, the length 320 of the tangible object 305-b may be proportional to the duration of the corresponding note (e.g., “3 sec note”). Although the tangible objects 305 are depicted as magnetic modular models in the example of FIG. 3, it is to be understood that other model types (such as vertical stacked models and hanging models) are also contemplated within the scope of the present disclosure.

In some implementations, each of the tangible objects 305 may represent a tone or note of a musical composition. For example, the tangible object 305-a may correspond to the first note of a song, and the tangible object 305-b may correspond to the second note of the song. The modular components of the tangible objects 305 may thus represent different portions of a musical note. For example, if the note “b1” is played for a duration of 3 seconds, the first modular component of the tangible object 305-a may correspond to the first second of the “b1” note, the third modular component of the tangible object 305-b may correspond to the third second of the “b1” note, etc. The techniques described herein may allow users to compose music in a tangible way, for example, by connecting the tangible object 305-a to the tangible object 305-b (indicating a “b1” note followed by a “cl” note) or vice versa.

Aspects of the object diagram 300 may be implemented to realize one or more of the following advantages. The techniques described with reference to FIG. 3 may enable users to create and interact with tangible objects 305 (i.e., magnetic, modular, musical tools). The object model(s) disclosed herein may enhance musical interactions through touch. In some examples, to create the tangible objects 305, a series of low-octave notes may be captured and physicalized using the system 100 and/or the system 200, as described with reference to FIG. 2. Each note may be played for a set duration (i.e., 3 seconds), processed, rendered, and physicalized, resulting the tangible objects 305. The techniques described herein may enable users to experience music (and other audio signals) through touch.

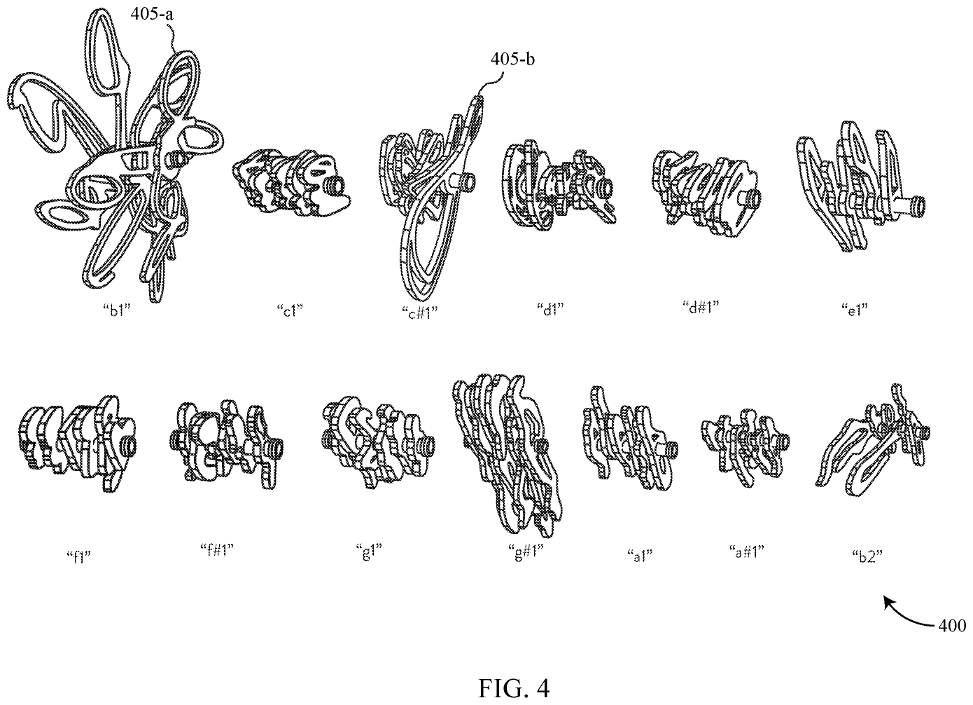

FIG. 4 shows an example of an object diagram 400 that supports techniques for using laser-based cymatics to physicalize sound in accordance with one or more aspects of the present disclosure. The object diagram 400 may implement or be implemented by aspects of any of the systems or object diagrams described with reference to FIGS. 1 through 3. For example, the object diagram 400 includes a tangible object 405-a, a tangible object 405-b, and a tangible object 405-c, which may be examples of corresponding objects described herein, including with reference to FIGS. 1 through 3. The tangible objects 405 may each be composed of modular slices that represent laser-projected shapes associated with a user-selected audio sample.

As described herein with reference to FIGS. 1 through 3, an individual may be exposed to a variety of sensory stimuli, such as auditory stimuli (i.e., sounds), olfactory stimuli (i.e., smells), visual stimuli (i.e., sights), gustatory stimuli (i.e., tastes), and tactile stimuli (i.e., textures). However, some individuals may be unable to fully experience or otherwise perceive certain types of stimuli. For example, individuals with visual impairments (such as blindness or vision loss) may be unable to perceive and/or process certain visual stimuli. Similarly, individuals with hearing impediments (such as deafness or hearing loss) may be unable to perceive and/or process certain auditory stimuli. In addition, some types of stimuli (such as visual and auditory stimuli) may be more prevalent than other types of stimuli (such as tactile stimuli), leading to sensory overstimulation (i.e., saturation) or under-stimulation (i.e., deprivation).

Cymatics generally refers to the process of converting auditory stimuli (for example, audio waveforms) into visual stimuli (for example, shapes) by capturing the vibrational effects that are caused (e.g., induced) by sound waves. As described herein, a sound wave may be defined as a sequence of longitudinal pressure waves (for example, waves in which the displacement of a medium is in the same direction as, or the opposite direction to, the direction of propagation) that expand or compress the molecules of a medium (such as air). Cymatics can be used to visualize the physical shape of captured sound. However, individuals with visual impairments (such as congenital blindness) may be unable to fully experience the visual effects of cymatics.

Aspects of the present disclosure support techniques for using cymatics to transform audio signals (for example, sound waves) into tangible objects 405, thereby enabling individuals to perceive and interact with the shape and texture of sound. In accordance with aspects of the present disclosure, a reflecting component may be appended to the front of a latex membrane, and a laser may be positioned such that a beam of the laser reflects off the reflecting component and onto an opaque surface (such as a canvas or screen). An exciter component may output an audio waveform associated with a user-selected audio sample (for example, a song or a voice recording). The audio waveform may cause the latex membrane and the reflecting component to oscillate. The oscillatory movement of the reflecting component may cause the reflected beam to fluctuate on the opaque surface. Images of laser-projected shapes created by the oscillatory motion may be captured, stored, and converted into data files.

Thereafter, the data files (e.g., vector files that include graphic information associated with the captured images) may be used to generate tangible objects 405 associated with the user-selected audio sample. For example, a laser cutter or 3D printer can be used to create modular objects (also referred to herein as slices or segments) based on the data files. In some implementations, these modular objects can be flexibly connected using directional magnets, thereby providing users with the ability to rotate and/or rearrange the modular objects. In some examples, the arrangement, length, or configuration of the modular objects may correspond to a specific musical note (such as b1), thereby enabling users to perceive audio tones/frequencies using other senses (such as sight and touch). As depicted in the example of FIG. 4, the tangible object 405-a may correspond to the musical note “b1”, the tangible object 405-b may correspond to the musical note “c#1”, and the tangible object 405-c may correspond to the musical note “f1”.

Aspects of the present disclosure may be implemented to realize one or more of the following advantages. The techniques described herein may provide individuals with a new way to interact with sound, for example, by enabling users to convert audio signals into tangible objects 405 that can be experienced through sight, smell, touch, and taste. In some examples, the techniques described herein may enable individuals with hearing impediments to process and/or interpret audio information using other sensory means. Furthermore, the described techniques may enable individuals with visual impairments to experience the sensory phenomena of cymatics (i.e., the visualization of sound) through touch. Additionally, the described techniques may provide individuals with an alternate way to read or compose musical works (for example, by rearranging or interacting with tangible objects 405 that correspond to musical notes).

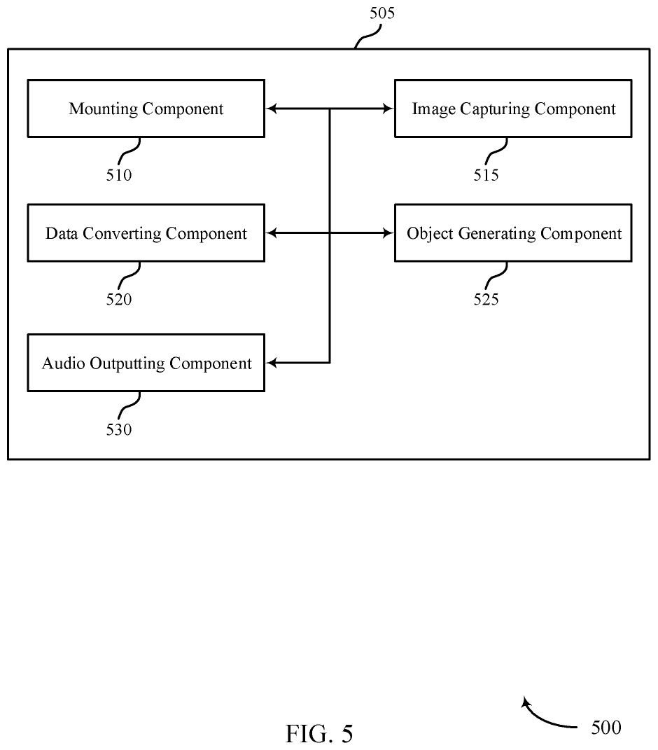

FIG. 5 shows a block diagram 500 of a system 505 that supports techniques for using laser-based cymatics to physicalize sound in accordance with one or more aspects of the present disclosure. The system 505 includes a mounting component 510, an image capturing component 515, a data converting component 520, an object generating component 525, and an audio outputting component 530.

The mounting component 510 may be configured as or otherwise support a means for mounting a reflecting component to a latex membrane that is attached to a compression ring, where the compression ring is coupled to an exterior housing component.

The mounting component 510 may be configured as or otherwise support a means for mounting a laser between the exterior housing component and a rigid shell component, where a beam of the laser is directed at the reflecting component mounted to the latex membrane, and where the beam of the laser reflects off of the reflecting component and onto an opaque surface.

The audio outputting component 530 may be configured as or otherwise support a means for causing an exciter component to output an audio waveform associated with a user-selected audio sample, where the exciter component is coupled to the rigid shell component, and where the audio waveform causes the latex membrane and the reflecting component to oscillate.

The image capturing component 515 may be configured as or otherwise support a means for capturing and storing images of the reflected beam on the opaque surface as the reflecting component oscillates in response to the audio waveform from the exciter component.

The data converting component 520 may be configured as or otherwise support a means for converting the stored images of the reflected beam on the opaque surface into one or more data files.

The object generating component 525 may be configured as or otherwise support a means for generating one or more tangible objects using the one or more data files associated with the stored images.

In some examples, the one or more data files are vector files that include graphic information associated with the stored images. In some examples, the one or more tangible objects are flexibly connected using directional magnets embedded in each of the one or more tangible objects.

In some examples, the one or more tangible objects are flexibly connected in a modular sequence that corresponds to a musical note. In some examples, the one or more tangible objects are flexibly connected and configured to rotate around a central axis.

In some examples, the one or more tangible objects are generated using a laser cutter. In some examples, the one or more tangible objects are made of plexiglass. In some examples, an angle between the laser and a central axis of the latex membrane is forty-five degrees.

In some examples, the images of the reflected beam are extracted from video footage of the opaque surface. In some examples, a collective length of the one or more tangible objects is proportional to a duration of the user-selected audio sample.

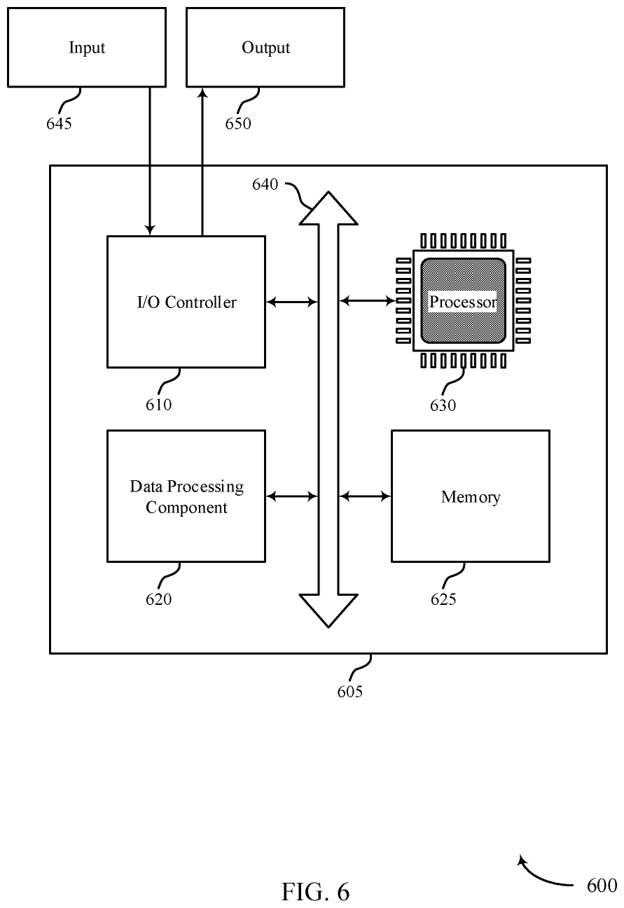

FIG. 6 illustrates a diagram of a system 600 including a device 605 that supports techniques for using laser-based cymatics to physicalize sound in accordance with one or more aspects of the present disclosure. The device 605 may include components for data communications, including components for transmitting and receiving communications, such as a data processing component 620, an I/O controller 610, a memory 625, and a processor 630. These components may be in electronic communication or otherwise coupled (e.g., operatively, communicatively, functionally, electronically, electrically) via one or more buses (such as a bus 640).

The I/O controller 610 may manage input signals 645 and output signals 650 for the device 605. The 1/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

Memory 625 may include random-access memory (RAM) and read-only memory (ROM). The memory 625 may store computer-readable, computer-executable software including instructions that, when executed, cause the processor 630 to perform various functions described herein. In some cases, the memory 625 may contain, among other things, a basic I/O system (BIOS) which may control basic hardware or software operation such as the interaction with peripheral components or devices.

The processor 630 may include an intelligent hardware device, (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in a memory 625 to perform various functions (e.g., functions or tasks supporting techniques for processing queries related to network security).

The data processing component 620 may support techniques for using laser-based cymatics to physicalize sound in accordance with one or more aspects of the present disclosure. For example, the data processing component 620 may be configured to support causing an exciter component to output an audio waveform associated with a user-selected audio sample, thereby causing a latex membrane and a reflecting component attached to the latex membrane to oscillate in response to the audio waveform, where a laser is directed at the reflecting component such that a beam of the laser reflects off the reflecting component and onto an opaque surface. The data processing component 620 may be configured to support capturing and storing images of the reflected beam on the opaque surface as the reflecting component oscillates in response to the audio waveform from the exciter component. The data processing component 620 may be configured to support converting the stored images of the reflected beam on the opaque surface into one or more data files. The data processing component 620 may be configured to support generating one or more tangible objects using the one or more data files associated with the stored images.

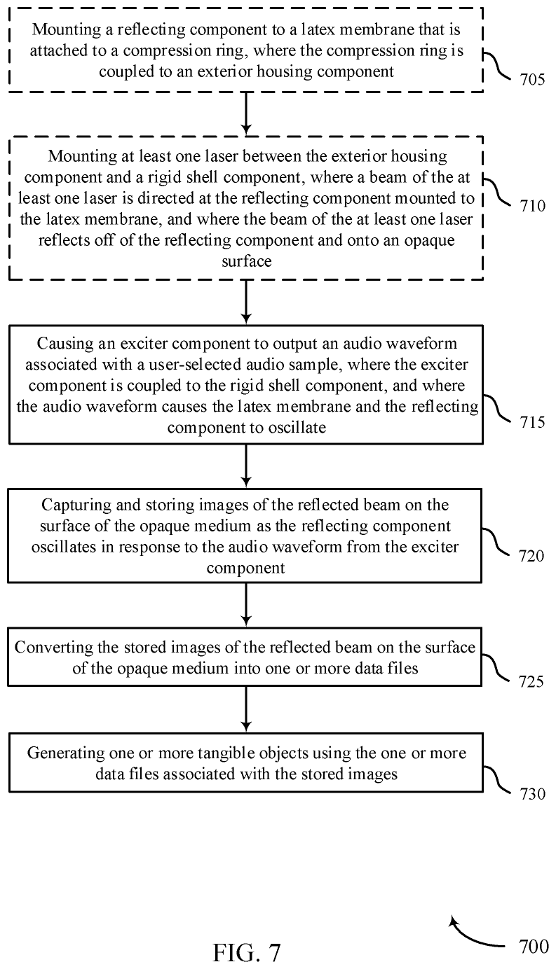

FIG. 7 illustrates a flowchart showing a method 700 that supports techniques for using laser-based cymatics to physicalize sound in accordance with one or more aspects of the present disclosure. The operations of the method 700 may be implemented by a system or components thereof, as described herein. For example, the operations of the method 700 may be implemented by one or more aspects of the system 200, as described with reference to FIG. 2. In some examples, the system may execute a set of instructions to control functional elements of the system to perform the described functions. Additionally, or alternatively, the system may perform aspects of the described functions using special-purpose hardware.

At 705, the method may optionally include mounting a reflecting component to a latex membrane that is attached to a compression ring, wherein the compression ring is coupled to an exterior housing component. The operations of 705 may be performed in accordance with examples disclosed herein. In some examples, aspects of the operations of 705 may performed by the mounting component 510, as described with reference to FIG. 5.

At 710, the method may optionally include mounting at least one laser between the exterior housing component and a rigid shell component, wherein a beam of the at least one laser is directed at the reflecting component mounted to the latex membrane, and wherein the beam of the at least one laser reflects off of the reflecting component and onto an opaque surface. The operations of 710 may be performed in accordance with examples disclosed herein. In some examples, aspects of the operations of 710 may performed by the mounting component 510, as described with reference to FIG. 5.

At 715, the method may include causing an exciter component to output an audio waveform associated with a user-selected audio sample, wherein the exciter component is coupled to the rigid shell component, and wherein the audio waveform causes the latex membrane and the reflecting component to oscillate. The operations of 715 may be performed in accordance with examples disclosed herein. In some examples, aspects of the operations of 715 may performed by the audio outputting component 530, as described with reference to FIG. 5.

At 720, the method may include capturing and storing images of the reflected beam on the opaque surface as the reflecting component oscillates in response to the audio waveform from the exciter component. The operations of 720 may be performed in accordance with examples disclosed herein. In some examples, aspects of the operations of 720 may performed by the image capturing component 515, as described with reference to FIG. 5.

At 725, the method may include converting the stored images of the reflected beam on the opaque surface into one or more data files. The operations of 725 may be performed in accordance with examples disclosed herein. In some examples, aspects of the operations of 725 may performed by the data converting component 520, as described with reference to FIG. 5.

At 730, the method may include generating one or more tangible objects using the one or more data files associated with the stored images. The operations of 730 may be performed in accordance with examples disclosed herein. In some examples, aspects of the operations of 730 may performed by the object generating component 525, as described with reference to FIG. 5.

A method is described. The method may include: mounting a reflecting component to a latex membrane that is attached to a compression ring, where the compression ring is coupled to an exterior housing component; mounting at least one laser between the exterior housing component and a rigid shell component, where a beam of the at least one laser is directed at the reflecting component mounted to the latex membrane, and where the beam of the at least one laser reflects off of the reflecting component and onto an opaque surface; causing an exciter component to output an audio waveform associated with a user-selected audio sample, where the exciter component is coupled to the rigid shell component, and where the audio waveform causes the latex membrane and the reflecting component to oscillate; capturing and storing images of the reflected beam on the opaque surface as the reflecting component oscillates in response to the audio waveform from the exciter component; converting the stored images of the reflected beam on the opaque surface into one or more data files; and generating one or more tangible objects using the one or more data files associated with the stored images.

An apparatus is described. The apparatus may include an exciter component coupled to a rigid shell component of the apparatus, where the exciter component is configured to output an audio waveform associated with a user-selected audio sample; an exterior housing component coupled to the rigid shell component; at least one laser mounted between the rigid shell component of the apparatus and the exterior housing component; a compression ring coupled to the exterior housing component; a latex membrane attached to the compression ring, where a surface of the latex membrane oscillates in response to the audio waveform associated with the user-selected audio sample; a reflecting component mounted to the latex membrane, where a beam from the at least one laser is directed at the reflecting component, and where the reflecting component oscillates with the surface of the latex membrane; an opaque surface, where the beam from the at least one laser is reflected off of the reflecting component and onto an opaque surface; and an image capturing component configured to capture and store images of the reflected beam on the opaque surface as the reflecting component oscillates in response to the audio waveform from the exciter component.

Another apparatus is described. The apparatus may include: means for mounting a reflecting component to a latex membrane that is attached to a compression ring, where the compression ring is coupled to an exterior housing component; means for mounting at least one laser between the exterior housing component and a rigid shell component, where a beam of the at least one laser is directed at the reflecting component mounted to the latex membrane, and where the beam of the at least one laser reflects off of the reflecting component and onto an opaque surface; means for causing an exciter component to output an audio waveform associated with a user-selected audio sample, where the exciter component is coupled to the rigid shell component, and where the audio waveform causes the latex membrane and the reflecting component to oscillate; means for capturing and storing images of the reflected beam on the opaque surface as the reflecting component oscillates in response to the audio waveform from the exciter component; means for converting the stored images of the reflected beam on the opaque surface into one or more data files; and means for generating one or more tangible objects using the one or more data files associated with the stored images.

In some examples of the methods and apparatuses described herein, the one or more data files may be vector files that include graphic information associated with the stored images. In some examples of the methods and apparatuses described herein, the one or more tangible objects may be flexibly connected using directional magnets embedded in each of the one or more tangible objects.

In some examples of the methods and apparatuses described herein, the one or more tangible objects may be flexibly connected in a modular sequence that corresponds to a musical note. In some examples of the methods and apparatuses described herein, the one or more tangible objects may be flexibly connected and configured to rotate around a central axis.

In some examples of the methods and apparatuses described herein, the one or more tangible objects may be generated using a laser cutter. In some examples of the methods and apparatuses described herein, the one or more tangible objects may be included of plexiglass.

In some examples of the methods and apparatuses described herein, an angle between the at least one laser and a central axis of the latex membrane may be forty-five degrees. In some examples of the methods and apparatuses described herein, the images of the reflected beam may be extracted from video footage of the opaque surface.

In some examples of the methods and apparatuses described herein, a collective length of the one or more tangible objects may be proportional to a duration of the user-selected audio sample.

The following provides an overview of aspects of the present disclosure:

Aspect 1: A method, comprising: mounting a reflecting component to a latex membrane that is attached to a compression ring, wherein the compression ring is coupled to an exterior housing component; mounting at least one laser between the exterior housing component and a rigid shell component, wherein a beam of the at least one laser is directed at the reflecting component mounted to the latex membrane, and wherein the beam of the at least one laser reflects off of the reflecting component and onto an opaque surface; causing an exciter component to output an audio waveform associated with a user-selected audio sample, wherein the exciter component is coupled to the rigid shell component, and wherein the audio waveform causes the latex membrane and the reflecting component to oscillate; capturing and storing images of the reflected beam on the opaque surface as the reflecting component oscillates in response to the audio waveform from the exciter component; converting the stored images of the reflected beam on the opaque surface into one or more data files; and generating one or more tangible objects using the one or more data files associated with the stored images.

Aspect 2: The method of aspect 1, wherein the one or more data files are vector files that comprise graphic information associated with the stored images.

Aspect 3: The method of any of aspects 1 through 2, wherein the one or more tangible objects are flexibly connected using directional magnets embedded in each of the one or more tangible objects.

Aspect 4: The method of any of aspects 1 through 3, wherein the one or more tangible objects are flexibly connected in a modular sequence that corresponds to a musical note.

Aspect 5: The method of any of aspects 1 through 4, wherein the one or more tangible objects are flexibly connected and configured to rotate around a central axis.

Aspect 6: The method of any of aspects 1 through 5, wherein the one or more tangible objects are generated using a laser cutter.

Aspect 7: The method of any of aspects 1 through 6, wherein the one or more tangible objects are made of plexiglass.

Aspect 8: The method of any of aspects 1 through 7, wherein an angle between the at least one laser and a central axis of the latex membrane is forty-five degrees.

Aspect 9: The method of any of aspects 1 through 8, wherein the images of the reflected beam are extracted from video footage of the opaque surface.

Aspect 10: The method of any of aspects 1 through 9, wherein a collective length of the one or more tangible objects is proportional to a duration of the user-selected audio sample.

Aspect 11: An apparatus, comprising: an exciter component coupled to a rigid shell component of the apparatus, wherein the exciter component is configured to output an audio waveform associated with a user-selected audio sample; an exterior housing component coupled to the rigid shell component; at least one laser mounted between the rigid shell component of the apparatus and the exterior housing component; a compression ring coupled to the exterior housing component; a latex membrane attached to the compression ring, wherein a surface of the latex membrane oscillates in response to the audio waveform associated with the user-selected audio sample; a reflecting component mounted to the latex membrane, wherein a beam from the at least one laser is directed at the reflecting component, and wherein the reflecting component oscillates with the surface of the latex membrane; an opaque surface, wherein the beam from the at least one laser is reflected off of the reflecting component and onto an opaque surface; and an image capturing component configured to capture and store images of the reflected beam on the opaque surface as the reflecting component oscillates in response to the audio waveform from the exciter component.

Aspect 12: The apparatus of aspect 11, further comprising: an image processing component configured to convert the stored images of the reflected beam on the opaque surface into one or more data files.

Aspect 13: The apparatus of aspect 12, further comprising: an object generating component configured to generate one or more tangible objects using the one or more data files associated with the stored images.

Aspect 14: The apparatus of any of aspects 12 through 13, wherein the one or more data files are vector files that comprise graphic information associated with the stored images.

Aspect 15: The apparatus of any of aspects 13 through 14, wherein the one or more tangible objects are flexibly connected using directional magnets embedded in each of the one or more tangible objects.

Aspect 16: The apparatus of any of aspects 13 through 15, wherein the one or more tangible objects are flexibly connected in a modular sequence that corresponds to a musical note.

Aspect 17: The apparatus of any of aspects 13 through 16, wherein the one or more tangible objects are composed of plexiglass.

Aspect 18: The apparatus of any of aspects 13 through 17, wherein the one or more tangible objects are flexibly connected and configured to rotate around a central axis.

Aspect 19: The apparatus of any of aspects 13 through 18, wherein a collective length of the one or more tangible objects is proportional to a duration of the user-selected audio sample.

Aspect 20: An apparatus, comprising at least one means for performing a method of any of aspects 1 through 10.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus, comprising:
an exciter component coupled to a rigid shell component of the apparatus, wherein the exciter component is configured to output an audio waveform associated with a user-selected audio sample;
an exterior housing component coupled to the rigid shell component;
at least one laser mounted between the rigid shell component of the apparatus and the exterior housing component;
a compression ring coupled to the exterior housing component;
a latex membrane attached to the compression ring, wherein a surface of the latex membrane oscillates in response to the audio waveform associated with the user-selected audio sample;
a reflecting component mounted to the latex membrane, wherein a beam from the at least one laser is directed at the reflecting component, and wherein the reflecting component oscillates with the surface of the latex membrane;
an opaque surface, wherein the beam from the at least one laser is reflected off of the reflecting component and onto an opaque surface; and
an image capturing component configured to capture and store images of the reflected beam on the opaque surface as the reflecting component oscillates in response to the audio waveform from the exciter component.

2. The apparatus of claim 1, further comprising:
an image processing component configured to convert the stored images of the reflected beam on the opaque surface into one or more data files.

3. The apparatus of claim 2, further comprising:
an object generating component configured to generate one or more tangible objects using the one or more data files associated with the stored images.

4. The apparatus of claim 3, wherein the one or more data files are vector files that comprise graphic information associated with the stored images.

5. The apparatus of claim 3, wherein the one or more tangible objects are flexibly connected using directional magnets embedded in each of the one or more tangible objects.

6. The apparatus of claim 3, wherein the one or more tangible objects are flexibly connected in a modular sequence that corresponds to a musical note.

7. The apparatus of claim 3, wherein the one or more tangible objects are made of plexiglass.

8. The apparatus of claim 3, wherein the one or more tangible objects are flexibly connected and configured to rotate around a central axis.

9. The apparatus of claim 3, wherein a collective length of the one or more tangible objects is proportional to a duration of the user-selected audio sample.

10. The apparatus of claim 1, wherein the images of the reflected beam are extracted from video footage of the opaque surface.
